(19) United States
(12) Patent Application Publication
(10) Pub. No.: US 2024/0419643 A1
(43) Pub. Date: Dec. 19, 2024

(54) Computer-implemented method for deduplication of equivalent data objects in a set of data objects, computer program product, and web-hosted software product

(71) Applicant: Risklick AG, Bern (CH)

(72) Inventors: Poorya AMINI, Bern (CH); Nikolay BORISSOV, Münchenbuchsee (CH)

(73) Assignee: Risklick AG, Bern (CH)

(21) Appl. No.: 18/334,268

(22) Filed: Jun. 13, 2023

(51) Int. Cl. G06F 16/215; G06F 16/23; G06F 16/25

(52) U.S. Cl. CPC G06F 16/215; G06F 16/2365; G06F 16/258

(57) ABSTRACT

The invention relates to a computer-implemented method for deduplication of equivalent data objects in a set of data objects, wherein each data object is provided with metadata fields; the method includes the steps:
inputting an input dataset comprising the set of data objects;
normalizing data comprised in metadata fields of a same metadata type;
calculating a similarity score between pairs of data objects using the normalized data;
clustering the data objects based on the calculated similarity score;
applying a filtering rule on the normalized data for identifying equivalent data objects in the clustered data objects;
deleting identified equivalent data objects and outputting a deduplicated dataset comprising deduplicated set of data objects and/or extracting identified equivalent data objects and outputting a duplicate dataset containing only identified equivalent data objects;
storing the deduplicated dataset and/or the duplicate dataset.

The invention also relates to a computer program product and a web-hosted software product.

### TECHNICAL DOMAIN

The present invention concerns a computer-implemented method for deduplication of equivalent data objects in a set of data objects, a computer program product, and a web-hosted software product. The invention enables users, such as scientists, to deduplicate data objects that can contain bibliographic data in a time-saving fashion and with high accuracy.

### RELATED ART

The following paper is hereby incorporated by reference: Borissov et al.; Reducing systematic review burden using Deduklick: a novel, automated, reliable, and explainable deduplication algorithm to foster medical research; Systematic Reviews; 2022; 11:172.

The primary objective of systematic reviews (SRs) and meta-analyses is to synthesize all available evidence within a specific research question's scope, while minimizing bias. SRs are common in numerous scientific fields, including chemistry, medicine, physics, and economic and social sciences. Researchers publish their findings in various databases and media, often in multiple languages, to achieve the necessary coverage, making SRs even more challenging.

These analyses are resource-intensive, requiring a median of five researchers and around 40 weeks of work to reach submission, such as discussed in Borah R, et al.; Analysis of the time and workers needed to conduct systematic reviews of medical interventions using data from the PROSPERO registry; BMJ Open; 2017; 7(2):e012545.

To conduct SRs in health sciences research, for example, researchers need to search multiple bibliographic databases, necessitating deduplication to eliminate duplicate records. Despite the importance of deduplication for ensuring SR quality, there is currently no universal method to omit or eliminate the need for deduplication, and the time-consuming task is mainly carried out manually.

To reduce time spent on the deduplication process, software tools were developed to simplify procedures and improve efficiency, although these require technical expertise and manual interventions. However, the deduplication process using these tools often involves lengthy manual procedures that may result in errors, thereby generally reducing quality.

### SHORT DISCLOSURE OF THE INVENTION

An aim of the present invention is the provision of a computer-implemented method for the deduplication of equivalent data objects in a set of data objects, a computer program product, and a web-hosted software product, each with the objective of overcoming the shortcomings and limitations of the state of the art.

Another aim is to provide a faster computer-implemented method for the deduplication of equivalent data objects in a set of data objects.

According to the first aspect of the present invention, a computer-implemented method for deduplication of equivalent data objects in a set of data objects involving the features recited in claim 1 is disclosed. Further features and embodiments of the computer-implemented method of the present invention are described in the dependent claims.

The invention relates to the computer-implemented method for deduplication of equivalent data objects in a set of data objects, wherein each data object is provided with metadata fields, the method includes the steps:
inputting an input dataset comprising the set of data objects;
normalizing data comprised in metadata fields of a same metadata type;
calculating a similarity score between pairs of data objects using the normalized data;
applying a filtering rule on the normalized data for identifying equivalent data objects in the clustered data objects;
deleting identified equivalent data objects and outputting a deduplicated dataset comprising deduplicated set of data objects and/or extracting identified equivalent data objects and outputting a duplicate dataset containing only identified equivalent data objects;
storing the deduplicated dataset and/or the duplicate dataset.

The computer-implemented method allows the deduplication of equivalent data objects in a set of data objects efficiently and reliably. Thus, the said method can enable users, such as scientists, to deduplicate data objects that can contain structured bibliographic data in a time-saving fashion and with a high degree of accuracy, leading to a deduplicated set of data objects of high quality. In addition, the computer-implemented method can be resource-efficient, which is especially advantageous for large amounts of data and can therefore require low computational time.

Alternatively, or in addition, standard deduplication process using tools available on the market can be error prone. The method as proposed can standardises the process, eliminates errors and can be fully transparent. The user can see and track the reasoning behind each decision made by the method and automatically receive a full report that can be obtained from and derived by the deduplicated dataset and/or the duplicate dataset. The method and the related software product (which will be discussed in a later section) can be scalable and can be used for large databases. It may event not require any specific expertise by the user.

The steps of the method can be executed or processed by a processor or an equivalent means in the order set out before. However, the order might be changed when required from a functional standpoint.

Data objects, in principle, can be referred to as a collection of one or more data points that can create meaning as a whole. In one example, the data object could be journal articles or other types of references.

The data object can contain metadata, such as bibliographic data. Bibliographic data may include, for example, authors' names, article titles, journal names, year of publication, volume, issue, and/or page number, etc.

The bibliographic data may be structured in metadata fields. The term field, however, can also relate to label, attribute, or the like and might be interchangeably used depending on the data structure and the programming language used. The metadata fields of the data objects in the input data dataset can include data of different data types, e.g., numeric type (integer, real, etc.), string, or other textual types.

The data objects can be stored in a database, such as a SQL database, or in a document, such as a XML, .txt. .csv. .xls document etc.

The metadata fields associated with or included in each data object can comprise a plurality of fields.

In some cases, metadata can be embedded in the data object itself, such as in the headers of a file, while in other cases, it may be stored separately in a different database record, in a separate database, or in another system.

Two data objects can be considered equivalent and thus form a duplicate if they share identical or nearly identical bibliographic data.

Thus, the principle objective of the computer-implemented method can be to deduplicate data objects, i.e., data objects having identical or widely similar metadata

The input dataset can be stored or located in a memory, such as the memory of a digital device, for instance, a computer, server, or cell phone. A processor of the digital device can be configured to execute the steps as set out herein before and can be provided to process the input dataset accordingly.

The goal of normalizing data (step of normalization) can be to ensure that different data fields from different sources are written in the same normalized way, even if the different sources write them differently. This normalization can make the comparison between duplicated data objects faster and more reliable.

The metadata comprised in a single data object can be individually normalized by applying predefined normalization rules. The normalization in groups, the so-called group normalization, can also be applied to the data objects, in particular to their metadata or metadata fields.

The step of normalizing data contained in the metadata fields can comprise the step of converting the data of different data types into a common data type, e.g. converting all data into a string.

This step can also comprise the step of harmonizing strings comprised in metadata fields of the same metadata type by removing or replacing special characters that can be contained in the string. A special character can be one that is not considered a number or letter. Therefore symbols, accent marks, and punctuation marks can be considered special characters, for instance. However, some metadata fields, such as a metadata field used to store a URL, may still need special characters.

The step of normalization of data comprised in the metadata fields can further include removing a URL prefix before or after the conversation into a string or other data type.

In particular and as a part of the normalization step, in case terms or words contained in a metadata field deviate from a predefined language, the terms or words can be translated into a common language, e.g. a language that is preferred for all metadata fields containing terms or words. The translation can be conducted using machine translation, including neuronal networks specifically trained for translation. It may be refined by further natural language processing to obtain a consistent representation of the terms or words.

A similarity score can be calculated between each possible pair of data objects, considering their metadata fields.

Two data objects in a pair can have a high similarity score if their metadata are identical or nearly identical. The similarity score associated with this pair can be lower if their metadata is more different.

Different metadata fields may be weighted differently for the calculation of the similarity score of each pair, because some fields can be more likely to be unique for a given data object, while other fields can be more likely to store an identical or nearly identical value even if the data objects are different. For example, the fact that the list of authors of two articles is identical does not necessarily mean that they are the same article, because it is relatively common for the same group of authors to publish two different articles. On the other hand, a title identity can be more likely to be a duplicate.

Two data objects sharing a same journal name may not necessarily be associated with a high similarity score, because several articles are usually published in each journal. If the journal, volume, and pages in two data objects are identical, then the similarity score associated with this pair can be very high.

The similarity score can be stored in the memory of the digital device in the form of a temporary file, in a database, or in a computer program variable. Alternatively, an additional metadata field can be used to keep the calculated similarity score in the form of a value.

Calculating the similarity score between two data objects can include the step of calculating the similarity score based on data included in the metadata fields of the same metadata type. The similarity score can be calculated using a string metric algorithm, such as an edit distance algorithm, preferably based on the Levenshtein distance.

The similarity score between two data objects in a pair can be higher if, for example, the metadata fields of the two data objects contain the same data, if the data contained has the same length or size, if it contains the same keywords, and/or the like. If the data fields are not identical, a distance may be computed between the two data fields and used to compute the score.

Clustering can relate to grouping data objects based on the calculated similarity score.

The number of similarity scores to compute can increase with the number of data objects. The time complexity can be defined as O(n log(n)), where n denotes the size of the data input. Therefore, the number of similarity scores to compute can become very high if the number of data objects is important.

It may therefore be preferable to use a fast algorithm to calculate the similarity score. A high similarity score only indicates some probability that the two data objects are duplicated.

In one example, all the pairs of data objects associated with a similarity score higher than a given threshold form clusters. Each cluster thus groups similar data objects. A cluster can include two or more than two similar data objects.

In a subsequent step, a set of filtering rules can be applied for identifying unique and duplicate data objects among the ones previously grouped in one of the clusters, i.e., the ones which are more to be duplicated.

Not all the data objects belong to one cluster, and the number of data objects in each cluster is usually limited. Therefore, the filtering rules used for detecting true duplicates in the previously identified clusters can be relatively slow but can be more conclusive than the algorithm previously used for computing the similarity score and forming the clusters.

If one data object duplicate in a group of the clustered data objects has been identified, this duplicate may be flagged as duplicate by adding a further metadata field containing the flag or value.

A plurality of filtering rules may be applied. Each rule may be based on a comparison of one type of metadata, or one predefined set of metadata type. Therefore, the filtering rules are functioning as exclusive rules.

A number of different rules can be applied. At least two, preferably three, more preferably five, or most preferably more than seven rules can be successively applied to confirm or exclude the presence of a duplicate.

The rules may be applied sequentially, i.e., one after the other. The rules may have priorities, i.e. some rules may be applied before others one.

Not all rules may be applied between each pair of data objects in the same cluster. Some high-priority rules may be applied first, and other filtering rules with lower priority may only be applied if the previously applied rules are not conclusive.

One example of a filtering rule may be based on a comparison between the following normalized metadata fields: Year-Title-Journal-Volume-Issue-Pages. Suppose all those metadata field may be identical among the data objects in a previously defined cluster. In that case, the data objects may almost certainly be duplicates and can be marked as such. Suppose a distance (such as a Levenshtein distance) between those metadata fields exceeds a predefined threshold. In that case, the data objects may be very likely unique and may not be marked as duplicates. If this distance is below the set threshold, but greater than zero (i.e. there are small differences), then the next rule will be applied to confirm or infirm the presence of duplicates.

The filtering rules can be a predefined set of rules that can be set before the execution of the computer-implemented method. However, a user can also be notified by displaying a dialog for entering or modifying the filtering rule. The equivalent data objects can be identified based on the entered filtering rule. It might also be possible that a set of filtering rules, applying different criteria for identifying duplicates, might be pre-defined or entered by a user. Preferably, the filtering rules can be predefined and customized, but can't be changed by the user in one execution cycle of the method.

Identified duplicate data objects using the filtering rule(s) can be deleted, whereas a copy of the duplicate data object might be stored in an independent dataset before deletion.

The computer-implemented method can also comprise the additional steps of:
inputting a second input dataset comprising a different second set of data objects;
inputting the deduplicated dataset comprising the deduplicated set of data objects;
merging the second input dataset and the deduplicated dataset for providing a merged input dataset;
repeating the steps of normalizing data, calculating the similarity score, clustering the data objects, applying the filtering rule, and deleting identified equivalent data objects in the merged input dataset;
updating the deduplicated dataset using the deduplicated merged input dataset.

Updating can include the step of replacing data objects comprised in the deduplicated dataset with data objects comprised in the deduplicated merged input dataset. Updating can also include the step of adding data objects not yet comprised in the deduplicated dataset from the deduplicated merged input dataset into the deduplicated dataset.

The computer-implemented method can also comprise the step of outputting a second duplicate dataset containing only identified equivalent data objects from the merged input dataset.

The computer-implemented method can further comprise the step of clustering of data objects comprised in the deduplicated dataset and linking of interrelated data objects from the clustered data objects. This step can be useful if the data objects, for instance, contain trials and related publication data in a deduplicated data set; they can be first clustered and then linked to one another. This can provide a better overview for a user.

According to another aspect, a computer program product is disclosed. The computer program product comprises program code, wherein the computer program product being configured to input a set of data objects from a memory, wherein each data object being provided with metadata fields, wherein the set of data objects includes duplicates of data objects, and wherein the computer program product being provided to output and store a deduplicated dataset and/or a duplicate dataset in the memory by executing the steps of the computer-implemented method of the first aspect.

The computer program product, in particular its code, can be stored on a digital device and can be executed by a processor of the digital device. The computer program product can be sold independently from or as a part of the digital device. By executing the computer-implemented method of the first aspect, the computer program product yields the same advantages.

According to the third aspect, a web-hosted software product is disclosed. The web-hosted software product is configured to execute the steps of the computer-implemented method of the first aspect, wherein the input dataset is uploaded by a user of the web-hosted software product.

The web-hosted software product can be a part of or a program instance on a server. Users can access the software product through a browser and can upload the input dataset to the software product. Such solutions are now known as software as a service, which allows users to use powerful servers without the need to have powerful computers at their disposal. This is particularly advantageous for mobile applications, such as those commonly found on smartphones nowadays. By executing the computer-implemented method of the first aspect, the web-hosted software product yields the same advantages.

The uploaded input dataset can be stored in a cloud storage and wherein the deduplicated dataset and/or the duplicate dataset can be stored on the same said cloud storage.

According to an independent further aspect of the invention, a computer-implemented method for clustering interrelated data objects is disclosed.

This aspect relates to the computer-implemented method for clustering of interrelated data objects in a set of suspected deduplicated data objects, wherein each data object is provided with metadata fields; the method includes the steps:
inputting a suspected deduplicated input dataset comprising the set of suspected deduplicated data objects;
normalizing data comprised in metadata fields of a same metadata type;
calculating a similarity score between pairs of data objects using the normalized data;
clustering the data objects based on the calculated similarity score;
involving a user for checking the clustered data objects;
marking or deleting duplicate data objects by a user input for deduplication of data objects;
storing the clustered dataset and/or a duplicate dataset.

The method can include a step of tagging or labeling each data object, e.g., by adding a tag or flag to the metadata fields, indicating the type of publication the data object belongs to. In particular, a tag or flag may indicate if the data object relates to a pre-print or a peer-reviewed publication. The said flag or tag can be used to cluster the data objects, which may relate to the publication of the same clinical trial (as an example). The flag or tag may be automatically added, e.g. by a processor. This can be achieved by determining the metadata fields. If a metadata field contains a disproportionate amount of structured numerical values, the data object likely concerns a clinical trial (for instance). Alternatively, a user can flag or tag the related data object manually.

All the aspects, as disclosed before, concerning the structure and definitions for the data objects, the calculation of the similarity score, the normalization of data, etc., may also apply to the present independent aspect. The present aspect can also be embodied as a computer program product comprising program code or a web-hosted software product. In summary, the present independent aspect can be combined or can take benefit of all the aspects disclosed herein before when it is useful and technically feasible.

The suspected deduplicated dataset can be entered into and processed by the computer-implemented method of the independent aspect, and the method can cluster again the one that was clustered during deduplication, for instance, by applying the computer-implemented method of the first aspect, but not removed because the said computer-implemented method was unsure that the data objects are duplicate or not. This can be useful and important when there are many pre-prints and original publications for the same literature in the data set. During deduplication, for instance, using the method of the first aspect, it can keep two (or more) almost identical data objects because they are not similar enough to be removed or deleted, but actually they are the same literature just published once as pre-print and later as peer review publication, and therefore interrelate. Most of the time after the peer review, the title of a pre-print is slightly changed and that can be why the deduplication method of the first aspect may not be able to find them exactly similar and keep both records. This independent aspect can be used as a complementary computer-implemented method and clusters the suspected deduplicated data objects again with the same principle and shows the similarity score. Then the user can check and decide very quickly if a data object relates to a pre-print of the same paper or not (for example), and the user can choose to mark or delete the data object after double-checking. This independent aspect can be used efficiently to drastically improve the quality (e.g. with less quantity) of the deduplicated dataset obtainable by the method disclosed for the first aspect, which suspiciously only contains deduplicated data objects.

In an alternative to the independent aspect, a computer-implemented method for clustering of interrelated data objects in a set of deduplicated data objects is disclosed. The computer-implemented method for clustering of interrelated data objects in a set of deduplicated data objects, wherein each data object is provided with metadata fields; the method includes the steps:
inputting a first and a second input dataset each comprising the set of deduplicated data objects;
normalizing data comprised in metadata fields of a same metadata type;
calculating a similarity score between pairs of data objects using the normalized data;
clustering the data objects based on the calculated similarity score;
storing the clustered dataset.

All the aspects, as disclosed before, concerning the structure and definitions for the data objects, the calculation of the similarity score, the normalization of data, etc., may also apply to the present independent aspect. The present alternative aspect can also be embodied as a computer program product comprising program code or a web-hosted software product. In summary, the present alternative aspect can be combined or can take benefit of all the aspects disclosed herein before when it is useful and technically feasible.

For instance, this alternative aspect can be useful for linking clinical trials and publications. This means that each clinical trial can have one or more publications. The trials and publications may be published on different platforms, so there may be no comprehensive way to link them otherwise. As part of the clustering, both (e.g. the clinical trials and the publications) can be brought together. It can be embodied such that the computer-implemented method of the alternative aspect inputs two files or data sets, one data set can contain deduplicated data objects representing studies or trials, and the second represents interrelated publications, also with deduplicated data objects. Preferably, the data objects representing the trials and publications can also be contained in a single file or data set. In this case, needs the method only to input one file or data det. The computer-implemented method of the alternative aspect then clusters the data objects and links them. This can further ease the workflow in the research activities of scientists.

### SHORT DESCRIPTION OF THE DRAWINGS

Exemplar embodiments of the invention are disclosed in the description and illustrated by the drawings in which:

FIG. 1 illustrates schematically a process for dedicating equivalent data objects in a set of data objects carried out by a processor.

FIG. 2 shows the process of FIG. 1, using as input datasets a deduplicated dataset and a dataset that includes duplicates of equivalent data objects.

### EXAMPLES OF EMBODIMENTS OF THE PRESENT INVENTION

Scientists conventionally start their systematic reviews by doing preparatory work, such as searching literature on specific research topics in different databases. Examples of databases used are Web of Science, Google Scholar, and IEEE Explore, to mention a few, whereby the used database depends on the research field. Literature that appears prima facie relevant for the specific research question conventionally is imported into a bibliography manager, such as BibDesk, RefWorks, Citavi, Endnote, etc. Dependent on the database used, the entries are imported into the bibliography manager with varying quality and quantity of data. Typically the citations imported are stored by the bibliography manager in memory using a digital format, such as the RIS format, and can contain citation information that includes title, author, publication date, publisher, keywords, and more information about the related citation. Other digital formats, such as .txt, .zip, .csv, etc. might be used instead, whereas the list is not exhaustive.

The bibliographic data of each citation can be stored in a single data object (i.e., a record) containing the kind of metadata mentioned, whereby the metadata can be arranged in different metadata fields. The metadata field can be of different metadata types, such that, for instance, the title information of the various citations contained in each data object can be easily identified and accessed.

To use a non-restrictive example, the citations may be arranged in a table format, with the top row defining fields of the metadata types and the rows below the top row containing the different citations, with the different metadata associated with a respective cell of a metadata type. Alternatively, and again non-limitingly, the citations may be arranged in an XML format, with each citation representing a data object of an XML file and each data object having associated attributes containing the respective metadata. An attribute can then be the title, author(s), etc. of the related citation. Of course, there are many other ways and possibilities to organize citations based on their metadata.

In general, however, a data object corresponds to one citation originating from one source that includes metadata that can be arranged in or assigned to metadata fields of different types. The metadata fields of different types can also contain data of different data types or data formats. The metadata fields, for instance, associated with the title T of the citations can be of the type “string”, whereas the metadata field containing the publication dates can be of the type “date” or “integer”. Again, the notation used shall not be limiting, as different programming languages use different terminologies.

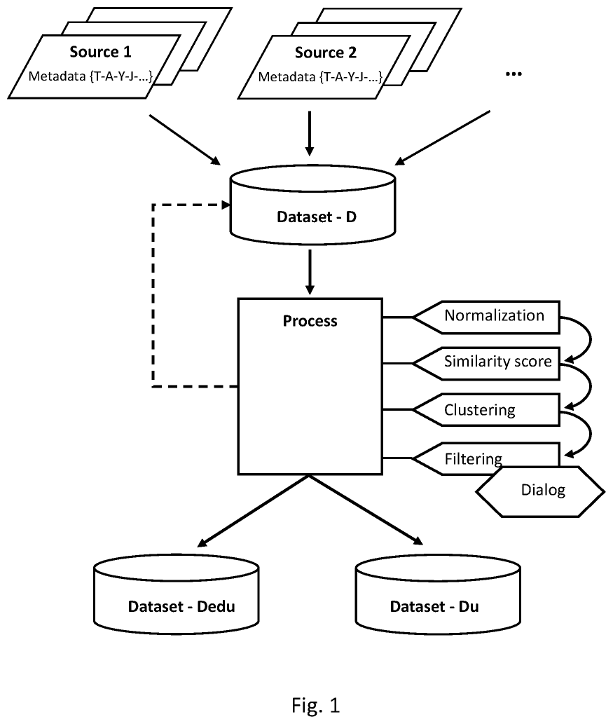

The process and related computer-implemented method illustrated in FIG. 1 can be available as a program, executable on a digital device, such as a computer, or executed as an instance on a server, such as those used for cloud computing applications.

As illustrated in FIG. 1, a first set of data elements, which includes metadata arranged in fields of the types Title T, Author A, publication date Y, journal J, and others, can originate from source 1 and a second set of metadata, equally arranged can originate from source 2, which can be a different database than used for the first set of data elements. Further sets of data elements can originate from further sources and are indicated by the three dots. All the data elements can be stored in the dataset-D, whereby the dataset-D can be managed and displayed by the bibliography manager used. As the data elements may originate from different sources, the dataset-D can contain data elements that concern the same citation but can contain slightly different metadata in the metadata field.

For example, the title T of one publication originating from source 1 may be “the little green tomato”, whereas the title T of the same publication originating source 2 may be “the green little tomato” (the example is fictitious). Also, the title T originating source 1 may be in English and the title T of the same publication originating from a different source may be in French. Therefore, it can be useful to eliminate the duplicate data elements that may concern the same publication but originate from different sources in order to increase the data uniqueness and the quality of the data in the dataset-D.

The process as illustrated, and according to the present example can start by inputting the dataset-D, which can be stored on a non-volatile memory comprised in a computer in a digital format, as indicated before. The process can run through each data object and can start to normalize the data comprised in the metadata fields. The normalization can begin with data alignment into a specific common data type. For instance, the metadata fields of the type publication date Y may store data as string, integer, or date format, depending on the source. The objective of the normalization would then be to convert the data of the related metadata fields into a string format, for instance. Having a standardized data format can reduce the effort in further processing the data. The metadata to be normalized in the present step can be the title, authors, journal, DOI, year, ISSN, volume, number of pages, URL, accession number to extract clinical trial number, etc., whereby the enumeration may not be exhaustive.

### Url and Accession Number to Extract Clinical Trial Number

At the same time, or subsequently, special characters can be removed from the string, or replaced with non-special characters. For example, German “a” may be replaced by “ae”. Particular attention might be drawn if a metadata field of the type “link” contains an URL that may refer to a website. In the removal of special characters, the URL prefix can be deleted as part of the data normalization task.

Some metadata fields, especially those of the type author A or publication date Y may comprise data in country-specific formats, such as the language used or a specific date format. Data of those metadata fields can be translated into a predefined language, such as English, using machine translation, whereas the translation can be refined using natural language processing such that the translation aligns with commonly used terminology.

Natural language processing may be used for the normalization of some data fields. For example, expressions like “volume”, “Volume”, “vol.”, “Vol” etc. may all be considered as a synonym and replaced by a normalized expression, such as volume.

The normalization may also include transliteration or adapting the transliteration. For example, proper names such as company names and person names, including author names, may be normalized by translating or transliterating them into standard language and a standard writing system. For example, sometimes the metadata can include the full name of a journal or an abbreviation thereof. The name of an author may be contained in different fashion or formats, such as family name, surname, or surname family name; or S. family name, etc.

Further tasks and processes not yet mentioned can be executed to normalize the metadata fields' data.

In a further step of the process, a similarity score between data objects is calculated among each pair of data objects.

The similarity score can be computed using the Levenshtein distance. The Levenshtein distance can be calculated between data contained in normalized metadata fields

Levenshtein distance is not the only string metric suitable for measuring the difference between two data objects. Therefore, other metrics, such as hamming distance, simple matching coefficient, etc. might be used instead for the calculation.

The result of the calculation of the similarity score among each possible pair of data objects is then used to cluster the data objects. A cluster can contain the authentic data object (data object representing one citation obtained from a first source, that can be the first publication or simply the first data object imported into the bibliography manager) and potential duplicates thereof. Depending on the size of the input dataset, the data objects can be clustered into a large number of subclusters, each containing the authentic data object of one citation and potential duplicates thereof. It goes without saying that if only one data object represents a single citation, the one data object doesn't need to be clustered.

In a subsequent step, a set of filtering rules are sequentially applied to each cluster of the clustered data objects. The primary objective may be to confirm whether the data objects in each cluster are duplicates or distinct. Since the number of clusters is usually limited, the number of data objects that need to be filtered is limited, so that a more complex and more time-consuming filtering process can be used than the algorithm used for computing the similarity scores.

A filtering rule may verify if the data in the normalized metadata field of type Title T of at least two data objects in one cluster are equal or broadly concurring; if they are different, the data objects can be considered to be distinct.

To improve the accuracy, the filtering rule, as defined before, may be applied to more than one type of metadata field. For instance, the filtering rule of containing equal or at least broadly concurring data can be applied to metadata fields of the type title T, author A, publication year Y, and so on. It was found that applying filtering rules on up to seven types of metadata fields may be required to provide sufficient accuracy.

As a non-limiting and non-exhaustive example, the following table might indicate which metadata fields might be considered and what action is taken by the method in case a duplicate is identified based on the comparison of the metadata fields, whereby the significance of similarity across metadata fields may decrease in descending order.

| Metadata field | Action |
|---|---|
| Author A - Year Y- Title T- | DELETE without checking |
| Journal - Volume - Issue - Pages | |
| Year Y - Title T - Journal - Volume - | DELETE without checking |
| Issue - Pages | |
| Author A - Year Y - Journal - | Involve user for manual |
| Volume - Pages | verification |
| Year Y - Title T - Journal - Volume - | Involve user for manual |
| Issue | verification |
| Author A - Year Y - Title - Volume - | Involve user for manual |
| Issue | verification |
| Year Y - Title T - Volume - Issue | Involve user for manual |
| | verification |
| Year Y - Title T - Volume | Involve user for manual |
| | verification |
| Year Y - Title T - Issue | Involve user for manual |
| | verification |
| Author A - Year Y - Volume - Issue | Involve user for manual |
| | verification |
| Year Y - Title T - Journal | Involve user for manual |
| | verification |
| Year Y - Title T | Involve user for manual |
| | verification |
| Title T | Involve user for manual |
| | verification |

The identified duplicate(s) can be flagged by adding a further metadata field to the data objects. Alternatively, the identified duplicates of the authentic data object can be extracted and stored in a separate file upon identification prior to the deletion of the duplicates.

The filtering rules can be stored as predefined filtering rules in a configuration file or the like. However, it is also possible to involve a user. Therefore a dialog can be displayed where the user can notice how the data objects are clustered, and the user may set individual filtering rules or modify the predefined filtering rules when required before the filtering step is executed. It may also be possible that the user already deletes or flags data objects prima facie duplicates of an authentic data object.

In the following step, only the data objects that were identified as being authentic (relating to one single citation, independently from the source from which it originates) may be stored in a deduplicated dataset-Dedu. The data objects identified as duplicates can be stored in a separate duplicate dataset-Du. Preferably, the input dataset-D may remain unmodified. Alternatively, all the steps as outlined before can be executed on the input dataset-D and thereby modifying (including replacing or deleting) the data objects using the mentioned steps. In any case, a separate duplicate dataset-Du can be generated so that users can reproduce the output. The formats of the output datasets can be built up on the digital formats mentioned earlier (.txt, .zip, .csv, etc.).

The computer-implemented method can be foreseen in a final step to generate a structured report in which the deduplicated dataset-Dedu is presented. The report can be outputted as PDF, office document, XML file, html document, etc. The report can also include information on how many duplicates were identified and removed from the input dataset-D, what filtering rules were applied, etc. By reading the report, the user should be able to comprehend how the input dataset-D has been processed and modified.

In summary, the process and the related computer-implemented method, as illustrated in FIG. 1, can significantly reduce the time spent on deduplication data objects containing bibliographic data obtained from different sources. The process is simple and efficient and can be implemented on a digital device resource-efficiently without fear of compromising output quality or purity.

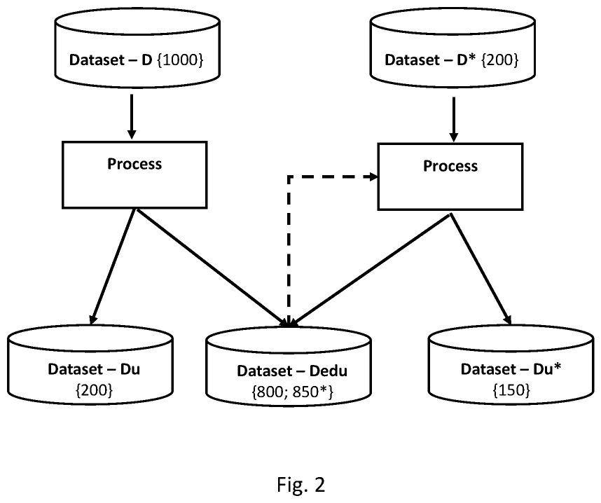

FIG. 2 shows on the left the process of FIG. 1, wherein the first input dataset-D might be structured as outlined in FIG. 1, and the data objects containing the bibliographic data of the citations might also originate from different sources. In this example, the first input dataset-D on the top left comprises a set of 1000 data objects, including authentic data objects and may contain duplicates thereof. By applying the process outlined in FIG. 1, a deduplicate dataset-Dedu comprising authentic data objects only can be generated and includes in this example 800 data objects. Obviously, 200 data elements were considered as duplicates in this example. The duplicates were extracted into a first duplicate dataset-Du noticeable on the bottom left, and can contain those 200 duplicated data objects. A user may have obtained a second input dataset-D*, which can be structured similarly to the first input dataset-D, and may also contain authentic data objects and duplicates thereof.

Before the process starts, the deduplicated dataset-Dedu containing 800 elements in addition to the second input dataset-D* may be combined such that the process can input the combined dataset comprising the deduplicated dataset-Dedu with 800 elements and the second input dataset-D* comprising 200 elements. The process as outlined for FIG. 1 can be executed once more, and an updated deduplicated dataset-Dedu can be generated, now containing in this example 850* elements. In addition, a second duplicate dataset-DU* can be generated, and may comprise the data elements that were considered as duplicates. The second duplicate dataset-DU* now can contains in this example 150 elements, and can include duplicate data elements that were solely comprised in the second input dataset-D* but may also include duplicates originating from the deduplicated dataset-Dedu that was inputted by the process.

The computer-implemented method, as explained in FIG. 2, can be foreseen with an additional final step in which a structured report is generated for presenting the deduplicated dataset-Dedu. The structured report can be foreseen to highlight new entries for each iteration (for each new input dataset) processed using the computer-implemented method.

By generating multiple duplicate datasets, it may be possible for users to trace on which database the deduplicate dataset-Dedu was created. Furthermore, inputting the deduplicated dataset-Dedu can lead to a reduction in the amount of data to be processed, which can also result in a gain in processing speed.

Conditional language used herein, such as, among others, “can,” “might,” “may,” “e.g.,” and the like, unless specifically stated otherwise, or otherwise understood within the context as used, is generally intended to convey that certain embodiments include, while other embodiments do not include, certain features, elements or states. Thus, such conditional language is not generally intended to imply that features, elements or states are in any way required for one or more embodiments or that one or more embodiments necessarily include logic for deciding, with or without author input or prompting, whether these features, elements or states are included or are to be performed in any particular embodiment.

The terms “comprising,” “including,” “having,” and the like are synonymous and are used inclusively, in an open-ended fashion, and do not exclude additional elements, features, acts, operations, and so forth. Also, the term “or” is used in its inclusive sense (and not in its exclusive sense) so that when used, for example, to connect a list of elements, the term “or” means one, some, or all of the elements in the list. Further, the term “each,” as used herein, in addition to having its ordinary meaning, can mean any subset of a set of elements to which the term “each” is applied.

1. A computer-implemented method for deduplication of equivalent data objects in a set of data objects, wherein each data object is provided with metadata fields; the method includes the steps:
inputting an input dataset comprising the set of data objects;
normalizing data comprised in metadata fields of a same metadata type;
calculating a similarity score between pairs of data objects using the normalized data;
clustering the data objects based on the calculated similarity score;
applying a filtering rule on the normalized data for identifying equivalent data objects in the clustered data objects;
deleting identified equivalent data objects and outputting a deduplicated dataset comprising deduplicated set of data objects and/or extracting identified equivalent data objects and outputting a duplicate dataset containing only identified equivalent data objects;
storing the deduplicated dataset and/or the duplicate dataset.

2. The computer-implemented method of claim 1, wherein the equivalent data objects in the set of data objects originate from different data sources.

3. The computer-implemented method of claim 1, wherein the metadata fields include data of different data types.

4. The computer-implemented method of claim 3, wherein the step of normalizing metadata fields comprises the step of converting the data of different data types into a common data type.

5. The computer-implemented method of claim 1, wherein the step of normalizing metadata fields comprises the step of harmonizing strings comprised in metadata fields of the same metadata type by removing special characters.

6. The computer-implemented method of claim 5, wherein the removal of special characters comprises the step of removing an URL prefix.

7. The computer-implemented method of claim 1, wherein the step of normalizing data included in the metadata fields comprises the step of translating strings representing a word comprised in metadata fields of the same metadata type into a common language using natural language processing.

8. The computer-implemented method of claim 1, wherein the step of calculating the similarity score includes the step of calculating the similarity score based on data included in the metadata fields of the same metadata type.

9. The computer-implemented method of claim 8, wherein the similarity score being calculated using a string metric algorithm.

10. The computer-implemented method of claim 9, wherein the string metric algorithm is provided as an edit distance algorithm, preferably Levenshtein distance algorithm.

11. The computer-implemented method of claim 1, wherein the filtering rule comprises the rule that the normalized data in at least two, preferably three, more preferably five, or most preferably seven metadata fields of a different metadata type are similar for identifying equivalent data objects.

12. The computer-implemented method of claim 1, comprising the step of notifying a user by displaying a dialog for entering the filtering rule and identifying equivalent data objects based on the entered filtering rule or on a pre-defined filtering rule.

13. The computer-implemented method of claim 1, comprising the steps of:
inputting a second input dataset comprising a different second set of data objects;
inputting the deduplicated dataset comprising the deduplicated set of data objects;
merging the second input dataset and the deduplicated dataset for providing a merged input dataset;
repeating the steps of normalizing data, calculating the similarity score, clustering the data objects, applying the filtering rule, and deleting identified equivalent data objects in the merged input dataset;
updating the deduplicated dataset using the deduplicated merged input dataset.

14. The computer-implemented method of claim 13, wherein updating includes the step of replacing data objects comprised in the deduplicated dataset with data objects comprised in the deduplicated merged input dataset.

15. The computer-implemented method of claim 13, wherein updating includes the step of adding data objects not yet comprised in the deduplicated dataset from the deduplicated merged input dataset into the deduplicated dataset.

16. The computer-implemented method of claim 13, comprising a step of outputting a second duplicate dataset containing only identified equivalent data objects from the merged input dataset.

17. The computer-implemented method of claim 1, comprising a step of clustering of data objects comprised in the deduplicated dataset and linking of interrelated data objects from the clustered data objects.

18. Computer program product comprising program code, wherein the computer program product being configured to input a set of data objects from a memory, wherein each data object being provided with metadata fields, wherein the set of data objects includes duplicates of data objects, and wherein the computer program product being provided to output and store a deduplicated dataset and/or a duplicate dataset in the memory by executing the steps of the computer-implemented method of claim 1.

19. Web-hosted software product, configured to execute the steps of the computer-implemented method of claim 1, wherein the input dataset is uploaded by a user of the web-hosted software product.

20. Web-hosted software product of claim 19, wherein the uploaded input dataset is stored in a cloud storage, and wherein the deduplicated dataset and/or the duplicate dataset is stored in the said cloud storage.
